(19) United States
(12) Patent Application Publication
(10) Pub. No.: US 2023/0046910 A1
(43) Pub. Date: Feb. 16, 2023

(54) MODULAR THERMAL CONTROL SYSTEM FOR A VEHICLE

(71) Applicant: GM GLOBAL TECHNOLOGY OPERATIONS LLC, Detroit, MI (US)

(72) Inventors: Neeraj S. Shidore, Novi, MI (US); Srinivasa Rao Vaddiraju, Troy, MI (US); Satish P. Ketkar, Troy, MI (US); Norman K. Bucknor, Troy, MI (US); Madhusudan Raghavan, West Bloomfield, MI (US)

(21) Appl. No.: 17/403,177

(22) Filed: Aug. 16, 2021

(51) Int. Cl. B60L 58/26; F28D 20/02; H01M 10/625; H01M 10/613; H01M 10/659; H01M 10/66

(52) U.S. Cl. CPC B60L 58/26; F28D 20/021; H01M 10/625; H01M 10/613; H01M 10/659; H01M 10/66; F28D 2021/0028

(57) ABSTRACT

A modular system for thermal control of a vehicle component includes a modular thermal control unit configured to be removably installed in a vehicle, the modular thermal control unit including a housing, a heat exchange component, and a connection assembly configured to removably connect the heat exchange component in thermal communication with a thermal loop of the vehicle.

### INTRODUCTION

The subject disclosure relates to thermal control of vehicle systems and components.

Vehicles, including gasoline and diesel power vehicles, as well as electric and hybrid electric vehicles, feature battery storage for purposes such as powering electric motors, electronics and other vehicle subsystems. In some cases, such as high performance situations, managing thermal properties of battery storage systems can be a challenge. For example, in racing contexts, battery storage and/or other vehicle features can generate additional heat that may be difficult for existing vehicle cooling systems to effectively dissipate. Accordingly, it is desirable to provide a device or system that can provide additional thermal management capabilities.

### SUMMARY

In one exemplary embodiment, a modular system for thermal control of a vehicle component includes a modular thermal control unit configured to be removably installed in a vehicle, the modular thermal control unit including a housing, a heat exchange component, and a connection assembly configured to removably connect the heat exchange component in thermal communication with a thermal loop of the vehicle.

In addition to one or more of the features described herein, the system further includes a first fluid line and a second fluid line configured to connect the modular thermal control unit in fluid communication with a coolant line of the thermal loop.

In addition to one or more of the features described herein, the connection assembly includes a detachable connector coupled to at least one of the first fluid line and the second fluid line, the detachable connector configured to removably connect at least one of the first fluid line and the second fluid line to the coolant line.

In addition to one or more of the features described herein, the heat exchange component includes a phase change material (PCM).

In addition to one or more of the features described herein, the modular thermal control unit includes a cavity configured to contain the PCM, and a fluid conduit configured to direct coolant from the thermal loop through the modular thermal control unit proximate to the cavity.

In addition to one or more of the features described herein, the cavity includes at least one barrier, the at least one barrier configured to partition the cavity into a plurality of chambers that retain the PCM therein and permit the PCM to uniformly transition between phases.

In addition to one or more of the features described herein, the modular thermal control unit is configured to be installed in an existing compartment of the vehicle.

In addition to one or more of the features described herein, the vehicle component includes a battery assembly, and the thermal loop includes a thermal management assembly configured to regulate a temperature of the battery assembly.

In one exemplary embodiment, a method of thermal control of a vehicle component includes installing a modular thermal control unit in a vehicle, the modular thermal control unit including a housing, a heat exchange component. The installing includes removably connecting the heat exchange component in thermal communication with a thermal loop of a vehicle. The method also includes controlling a temperature of the vehicle component by the modular thermal control unit.

In addition to one or more of the features described herein, during vehicle operation, monitoring a temperature of the vehicle component, and based on the temperature exceeding or expected to exceed a selected threshold temperature, controlling the temperature by actuating the modular thermal control unit to dissipate heat from the thermal loop.

In addition to one or more of the features described herein, the modular thermal control unit is connected to a first fluid line and a second fluid line, at least one of the first fluid line and the second fluid line connected to a valve, the valve configured to be actuated to put the modular thermal control unit in fluid communication with a coolant line of the thermal loop.

In addition to one or more of the features described herein, the controlling includes actuating the valve to an open position in which the valve provides fluid communication with the coolant line.

In addition to one or more of the features described herein, the valve is kept in the open position prior to the monitoring for a time period sufficient to prime the modular thermal control unit.

In addition to one or more of the features described herein, the controlling includes actuating the valve to an open position in response to the temperature exceeding the selected threshold temperature.

In addition to one or more of the features described herein, the heat exchange component includes a phase change material (PCM).

In addition to one or more of the features described herein, the heat exchange component includes a phase change material (PCM), and the time period is sufficient to allow the phase change material to cool and solidify.

In one exemplary embodiment, a vehicle system includes a memory having computer readable instructions, and a processing device for executing the computer readable instructions, the computer readable instructions controlling the processing device to perform a method. The method includes, during vehicle operation, monitoring a temperature of a component of a vehicle, the vehicle including a modular thermal control unit installed therein, the modular thermal control unit including a housing and a heat exchange component, the heat exchange component removably connected to a thermal loop of the vehicle via a connection assembly. The method also includes, based on the temperature exceeding a selected threshold, controlling the modular thermal control unit to dissipate heat from the thermal loop.

In addition to one or more of the features described herein, the modular thermal control unit is connected to a first fluid line and a second fluid line, at least one of the first fluid line and the second fluid line connected to a valve, the valve configured to be actuated to put the modular thermal control unit in fluid communication with a coolant line of the thermal loop.

In addition to one or more of the features described herein, the controlling includes actuating the valve to an open position in response to the temperature exceeding or expected to exceed the selected threshold temperature.

In addition to one or more of the features described herein, the heat exchange component includes a phase change material (PCM).

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including various thermal management systems and a modular thermal control system, in accordance with an exemplary embodiment;

FIG. 2 depicts a modular thermal control system installed in a vehicle, in accordance with an exemplary embodiment;

FIG. 3 is a front, cross-sectional view of a modular cooling or thermal control unit having a heat exchanger that includes a phase change material (PCM), in accordance with an exemplary embodiment;

FIGS. 4A-4C are side views of embodiments of the modular thermal control unit of FIG. 3;

FIG. 5 is a flow diagram depicting aspects of a method of thermal control of a vehicle component, in accordance with an exemplary embodiment; and

FIG. 6 is a graph of vehicle battery assembly temperature, illustrating an example of thermal control of the battery assembly using the modular thermal control system of FIG. 2.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for thermal control of one or more vehicle subsystems and/or components. A modular thermal control system includes a modular thermal control unit configured to be removably installed into a vehicle and connected in thermal communication with one or more vehicle subsystems or components, such as a battery assembly, a motor or engine cooling system, an electronics cooling system and/or a heating, ventilation and air conditioning (HVAC) system. The modular thermal control unit is used to increase the capability of existing thermal loops (e.g., for enhanced vehicle performance). The modular thermal control unit includes a housing that is sized and shaped to be installed in a selected vehicle location, such as a front or rear trunk. In an embodiment, the modular thermal control unit includes a phase change material (PCM).

Embodiments also include methods of thermal control of a vehicle system or component (e.g., a battery assembly) that includes installing the modular thermal control unit in the vehicle, connecting the thermal control unit via fluid lines and detachable connectors to a thermal loop (or any other temperature control system or device) of a vehicle, and operating the modular thermal control unit to control a temperature of a vehicle component (e.g., by heating or cooling the vehicle component).

An embodiment of a method includes actuating the modular thermal control unit to facilitate dissipation of heat from a thermal loop of a thermal management system, such as a battery thermal management system. In an embodiment, the method includes monitoring a temperature of a vehicle component or system, and controlling the modular thermal control unit to dissipate heat from the thermal loop in response to the temperature exceeding a selected threshold. The method may include priming or conditioning the modular thermal control unit prior to vehicle operation and/or monitoring.

Embodiments described herein present numerous advantages and technical effects. The embodiments allow flexibility to provide additional thermal control or cooling to existing vehicle thermal management systems as needed. The modular thermal control system is compact and can be easily installed in already available vehicle compartments.

Existing cooling systems may be limited in the amount of heat they can dissipate from batteries, in situations such as racing and other high performance situations. Embodiments provide a compact, modular unit that can be easily installed to provide additional heat dissipation.

For example, track maneuvers present significant challenges to the thermal system of a vehicle, due to significant low grade heat generated by the vehicle battery. Existing solutions call for significant increase in heat rejection through refrigeration. Such solutions typically add weight and can be a packaging challenge, and may not be able to maintain the battery under prescribed limits (e.g., 60 deg C), leading to performance degradation (e.g., high lap times). Embodiments described herein address such challenges by providing a compact, modular system that can be selectively installed when conditions call for additional thermal management. The embodiments avoid the weight and packaging challenges, and can prevent derating of battery power due to battery temperature exceeding prescribed limits.

The embodiments are not limited to use with any specific vehicle and may be applicable to various contexts. For example, embodiments may be used with automobiles, trucks, aircraft, construction equipment, farm equipment, automated factory equipment and/or any other device or system for which additional thermal control may be desired to facilitate a device or system's existing thermal control capabilities or features.

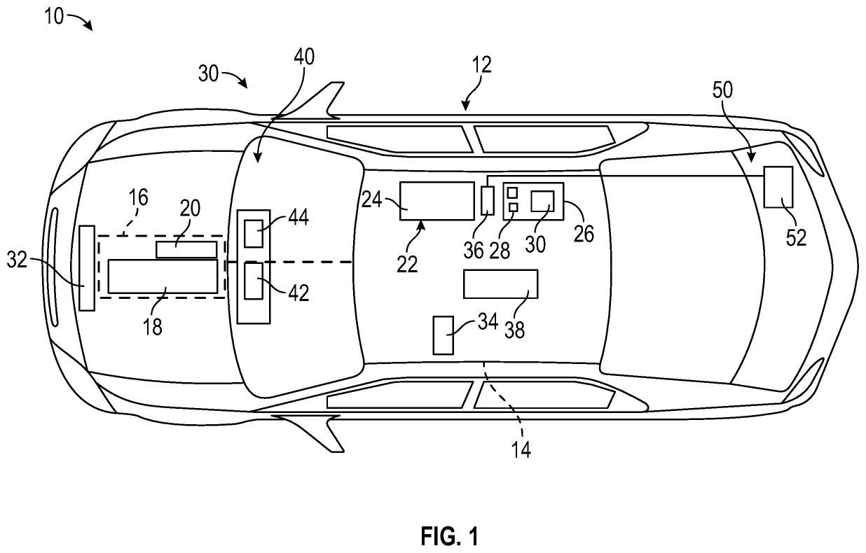

FIG. 1 shows an embodiment of a motor vehicle 10, which includes a vehicle body 12 defining, at least in part, an occupant compartment 14. The vehicle body 12 also supports various vehicle subsystems including a propulsion assembly 16, and other subsystems to support functions of the propulsion assembly 16 and other vehicle components, such as a braking subsystem, a suspension system, a steering subsystem, a fuel injection subsystem, an exhaust subsystem and others.

The vehicle may be a combustion engine vehicle, an electrically powered vehicle (EV) or a hybrid vehicle. In an example, the vehicle 10 is a hybrid vehicle that includes a combustion engine assembly 18 and an electric motor assembly 20.

The vehicle 10 includes a battery assembly 22, which may be electrically connected to the motor assembly 20 and/or other components, such as vehicle electronics. In an embodiment, the battery assembly 22 is configured as a rechargeable energy storage system (RESS), and includes a high voltage battery pack 24 and a control unit 26. The control unit 26 includes a sensor array 28 and a controller 30. The controller 30 includes components such as a processor, memory, an interface, a bus and/or other suitable components.

The vehicle 10 also includes a thermal management system or systems that define a plurality of thermal loops for regulating (cooling and/or heating) temperature of vehicle subsystems. For example, a thermal management system of the vehicle 10 includes a cooling assembly 32 for regulating temperature of the engine assembly 18, the electric motor assembly 20 and/or electronics. An HVAC unit 34 is included for regulating temperature in the vehicle compartment 14.

The thermal management system includes an RESS thermal management assembly 36 that is controlled by the control unit 26 (alone or in conjunction with an ECU 38) to maintain a temperature of the RESS to within selected limits. The RESS temperature may be maintained by monitoring the voltage, current and/or temperature values associated with the RESS by the sensor array 28, and thermally conditioning the RESS when the RESS temperature approaches an upper or lower RESS temperature limit.

The vehicle 10 includes various processing devices and/or units for controlling aspects of the vehicle. For example, an electronic control unit (ECU) 38 is included to control operation of components of the thermal management system and/or other vehicle subsystems. The vehicle 10 also includes a computer system 40 that includes one or more processing devices 42 and a user interface 44. The various processing devices and units may communicate with one another via a communication device or system, such as a controller area network (CAN) or transmission control protocol (TCP) bus.

In an embodiment, a modular thermal control system 50 is installable in the vehicle 10 to enhance thermal control capabilities of existing thermal management systems. The modular thermal control system 50 includes a modular, detachable thermal control unit 52 that can be removably installed (i.e., can be installed and removed as needed) at a selected location in the vehicle 10. In the embodiment of FIG. 1, the modular thermal control unit 52 is configured to be installed in a rear trunk area, but is not so limited and can be installed at any suitable location. As discussed further herein, the modular thermal control unit 52 includes a housing in which a heat exchange component or system is disposed (e.g., a phase change material), and components for releasably installing the modular cooling unit and connecting the unit to one or more thermal loops in the vehicle.

The modular thermal control unit 52 is described in embodiments as being configured to dissipate heat from a thermal loop, and is referred to in such embodiments as a modular cooling unit 52. It is noted that the embodiments, as well as the thermal control system 50 and the modular thermal control unit 52, are not limited to cooling, as the thermal control system 50 can be used to inject heat via, for example, a thermal loop. For example, a phase change material or other heat exchange component can be installed in a heated state (e.g., at a temperature above an initial battery temperature) and connected to a thermal loop to apply heat thereto. For example, in extremely cold conditions, the thermal control system 50 can provide extra heating capability to warm up a battery or batteries prior to charging and vehicle operation. Accordingly, it is to be understood the embodiments described herein can include injecting heat or applying heat to a component, either in place of cooling or in addition to cooling.

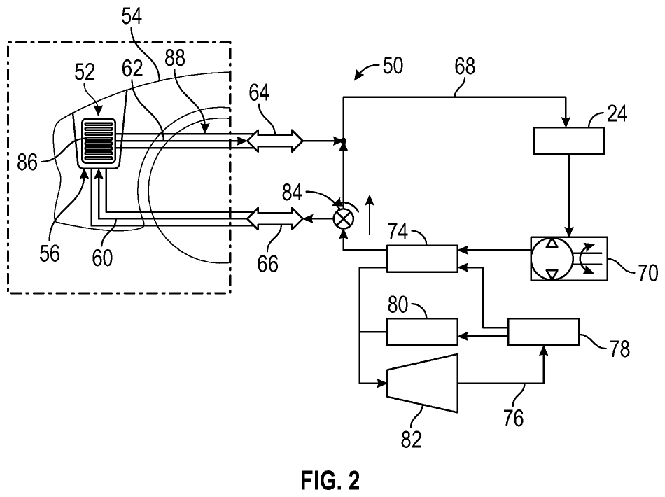

FIG. 2 depicts an embodiment of the modular thermal control system 50 as installed in a vehicle 54. In this embodiment, the modular thermal control unit 52 is installed in a front storage space 56 (“frunk”), but is not so limited.

The thermal control unit 52, when installed, is connected in fluid communication with one or more thermal loops of the vehicle 54 via detachable connectors. For example, the thermal control unit 52 includes fluid lines 60 and 62, which are connected via respective quick disconnect ports 64 and 66 to an existing thermal loop of the RESS thermal management assembly 36. It is noted that the thermal control unit 52 may be connected to any desired thermal loop for cooling and/or heating, such as an electronics or motor cooling unit, or HVAC loop.

In an example, the thermal management system of the vehicle 54 includes a coolant loop including a coolant line 68 that applies coolant to the RESS 24 (thermal management unit). The thermal control unit 52 in this example is configured as a cooling unit. Coolant flows through the coolant line 68 to a pump 70, and then through a chiller 74 that includes a refrigerant-to-coolant heat exchanger (not shown).

The thermal management system also includes a refrigerant loop having refrigerant lines 76. The refrigerant loop includes the chiller 74, a condenser 78, an evaporator 80 and a compressor 82.

The quick connect ports 64 and 66 are provided to releasably connect the fluid lines 60 and 62 to the coolant loop via a three-way valve 84. When the cooling unit 52 is installed and the valve 84 is actuated to an open position, some of the coolant flowing through the coolant line 68 from the chiller 74 is redirected into the fluid line 60 and into a heat exchange component 86 in the cooling unit 52. The heat exchange component 86 absorbs heat from coolant flowing through the cooling unit 52 and dissipates heat from the coolant. The coolant returns to the coolant line 68 through the fluid line 62. In this way, the cooling unit 52 is configured to enhance the heat dissipation capabilities of the thermal management system and/or RESS thermal management system.

The heat exchange component may be any device, material, assembly or system that can be housed in the cooling unit 52 and be used to absorb heat from the coolant. In an embodiment, the heat exchange component is a phase change material (PCM), which may be any of various substances or combination of substances that changes phase (e.g., between liquid and solid). Examples of PCMs include water and wax-based materials. Other types of heat exchange components include heat sink materials (e.g., metal), other thermally conductive materials, thermoelectric coolers and others.

The modular thermal control system 50 may include additional components to facilitate heat dissipation. For example, the fluid line 60 and/or 62 may be surrounded by a sleeve or other mechanism that removes heat from the coolant as the coolant flows through the fluid lines. In an embodiment, the cooling lines are surrounded by sleeves 88 that define annular passages around the fluid lines, in which a phase change material or other substance that can absorb heat is contained.

Although only two thermal loops are shown, the vehicle 54 may have any number of loops. For example, coolant and/or refrigerant can be directed to other vehicle subsystems via suitable control valves.

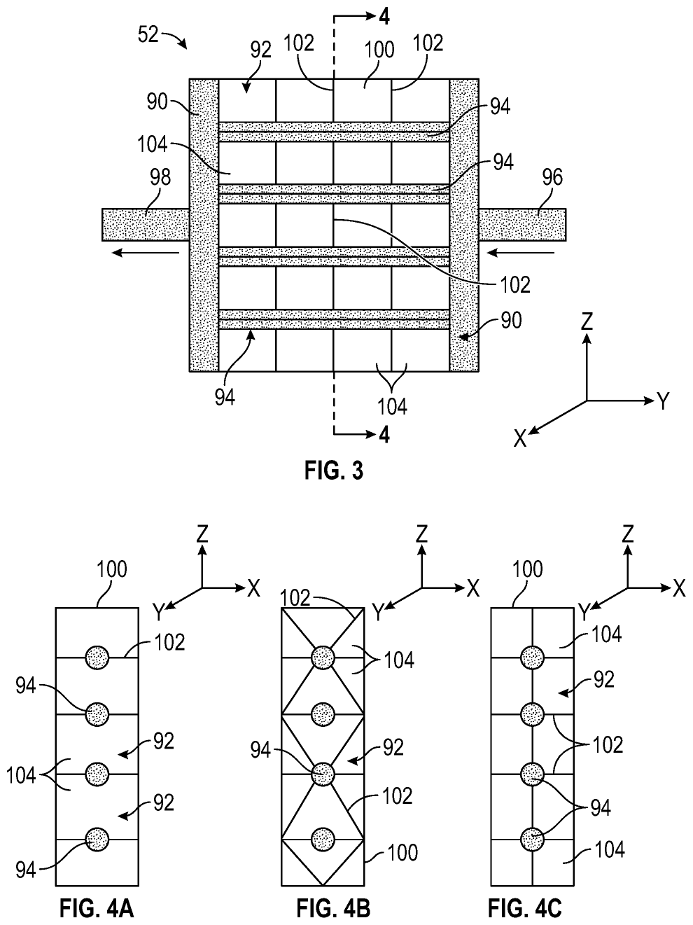

FIG. 3 depicts an embodiment of the thermal control unit 52, which includes a phase change material. FIG. 3 is a front cross-sectional view in a plane defined by a z-axis and a y-axis (of a three-dimensional space defined by orthogonal axes x, y and z). The thermal control unit 52 is configured, for example as a cooling unit 52. Although the thermal control unit 52 is discussed as a cooling unit 52 for dissipation of heat using the phase change material, the thermal control unit may also be configured to inject heat into a system.

The cooling unit 52 includes a housing 90 that contains a phase change material (PCM) 92, such as a water-based or wax-based substance (paraffin) within one or more cavities (e.g., a cavity 100 discussed herein) and/or chambers (e.g., chambers 104 discussed herein). The housing 90 may be insulated to prevent undesired amounts of heat from escaping to other locations in a vehicle. The PCM 93 can be initially disposed in the cooling unit 52 in a selected state (e.g., solid or liquid, or a combination of solid and liquid). For example, the PCM 92 may be initially disposed in the cooling unit 52 in a molten or liquid state (or a combination thereof, such as a combination of ice and water), and may stay in the liquid state or become solid as the cooling unit absorbs heat during vehicle operation.

The housing 90 includes one or more fluid conduits or channels through which coolant flows when the cooling unit 52 is in use, and one or more cavities in which the PCM 92 is contained. The PCM 92 is filled and sealed within the cavity or cavities prior to use. In an embodiment, the amount of PCM 92 in each cavity is such that the PCM entirely or substantially fills each cavity when in the solid phase. Coolant passages and cavities are designed to generate appropriate heat transfer to the PCM 92, while minimizing pressure drop, weight and volume.

The housing 90, in an embodiment, includes a plurality of coolant channels 94, which are configured so that coolant flowing through the unit 52 is proximate to the PCM 92 and heat can be effectively transferred. The coolant channels 94 are in fluid communication with an inlet 96 and an outlet 98, which may be connected to fluid lines, such as the fluid lines 60 and 62.

The housing 90 also includes a cavity 100 that extends along and surrounds each coolant channel 94, and that is filled with the PCM 92. In an embodiment, the cavity 100 is entirely filled with the PCM 92, or is partially filled so that the PCM 92 fills the entire volume of each cavity 100 if the PCM 92 expands when solidifying.

In an embodiment, the cavity 100 includes a barrier or barriers that define individual chambers therein. For example, the cavity 100 includes a plurality of barriers 102 that define respective chambers 104, each of which are individually filled with the PCM 92. A PCM 92 in a given chamber 104 is physically separated and cannot flow to another chamber. Each barrier 102 may be a thin sheet or layer (also referred to as a fin) of a metal or lightweight material having high thermal conductivity, such as a graphite or metal. The fin structure may be in any of various configurations and define any number of chambers. In addition, the fin structure is selected to define chambers having any of various volumes and geometries.

FIGS. 4A-4C are side cross-sectional views of the cooling unit 52 of FIG. 3 in a plane defined by a reference line 4-4 shown in FIG. 3, and illustrate examples of different fin configurations. FIG. 4A shows an example in which horizontal (i.e., extending in a direction of the x-axis) barriers 102 separate the cavity into rectangular shaped chambers 104, and FIG. 4B shows an example in which the barriers 102 define triangular chambers 104. FIG. 4C shows an example that includes horizontal and vertical (i.e., extending in a direction of the z-axis) barriers 102. Generally, the cavity 100 and the chambers 104 are designed to facilitate heat transfer, restrict movement of molten PCM and allow the PCM to uniformly return to a solid state.

It is noted that the specific size, shape and configuration of the cavity 100, the coolant channels 94, and the chambers 104 are not limited to that shown in FIG. 3, as any of various designs may be used. For example, the cavity 100 may not include fins or barriers, but instead may include a non-homogeneous mixture of materials. An example of such a mixture includes a PCM in combination with a metal and graphite.

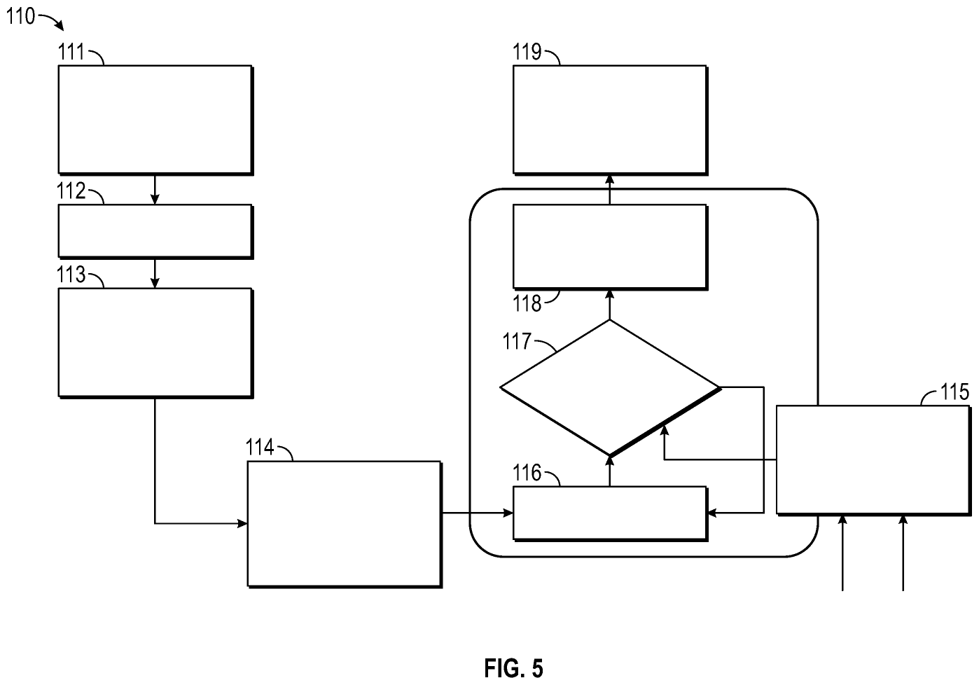

FIG. 5 illustrates embodiments of a method 110 of operating a vehicle and thermal control of one or more vehicle components. Aspects of the method 110 (e.g., temperature monitoring and valve actuation) may be performed by a processor or processors disposed in a vehicle (e.g., as an ECU or on-board computer). Other aspects (e.g., installing the modular cooling unit and driving) may be performed by a driver or other human operator. It is noted the method 110 is not so limited and may be performed by any suitable processing device or system, or combination of processing devices.

The method 110 includes a number of steps or stages represented by blocks 111-119. The method 110 is not limited to the number or order of steps therein, as some steps represented by blocks 111-119 may be performed in a different order than that described below, or fewer than all of the steps may be performed.

The method 110 is discussed in the context of high performance operation of a vehicle, such as track racing, for illustrative purposes. The method is not so limited and can be performed in any context or any operating mode for which additional cooling or thermal control is desired.

At block 111, during preparation for track maneuvers, the driver places the cooling unit 52 in a vehicle compartment, such as the front trunk 56. Fluid lines 60 and 62 are connected to the vehicle's battery thermal loop via the quick disconnect ports 64 and 66.

At block 112, the driver puts the vehicle into a high performance mode (e.g., track mode). At block 113, the vehicle initiates battery preconditioning (e.g., to 25 degrees C.).

At block 114, the cooling unit 52 and the PCM 92 are optionally primed or preconditioned prior to performing track maneuvers (or other vehicle operations) by establishing fluid communication between the cooling unit 52 and the thermal loop. For example, the three-way valve 84 is opened and coolant is allowed to flow through the cooling unit 52 until a desired temperature is reached. For example, the valve is maintained in an open position until the temperature of the PCM 92 reduces to a desired extent. Depending on the type of PCM used, the PCM 92 may change phase as a result of the preconditioning (e.g., liquid to solid) or stay in the same phase (e.g., liquid).

At block 115, properties of the vehicle's battery assembly and expected conditions are used to estimate a threshold temperature value. For example, the threshold temperature is a critical temperature (e.g., 60 degrees C.), which is estimated based on battery state, battery load trajectory, power draw, and others. The critical temperature may be any selected temperature value or temperature range. For example, the critical temperature can be a battery high temperature limit (e.g., the highest temperature at which the battery can safely and effectively operate and/or a manufacturer's specified temperature limit) or at any selected temperature value or range below the high temperature limit.

At block 116, when track maneuvers are being performed, the valve 84 is closed to bypass the cooling unit 52. At block 117, a processing device (e.g., a thermal management unit, ECU or other suitable processing unit) monitors the temperature of the vehicle's battery assembly.

At block 118, the processing device causes the valve 84 to be actuated or opened (e.g., from a closed position to an open position, or moved to one of a plurality of open positions in the case of a variable valve) based on detecting one or more temperature conditions of the batter assembly. A temperature condition may be a condition in which the battery assembly temperature is approaching the critical temperature, is at the critical temperature, is expected to exceed the critical temperature, or is exceeding the critical temperature. If the battery assembly meets one or more of the temperature conditions, the valve 84 is actuated or opened, and the PCM 92 absorbs heat from coolant. When the battery temperature falls below the critical temperature or otherwise no longer meets any of the above conditions, the valve 84 is again closed. The valve 84 may be actuated or opened in response to one or more control signals, such as one control signal or a combination of control signals indicative of various temperature conditions or values.

The processing device may consider that the battery assembly temperature is expected to exceed the critical temperature based on one or more measured temperature values and/or one or more measured rates of temperature change (e.g., rate or rates of increase). For example, the battery assembly temperature can be predicted to exceed the critical temperature at some future time if the rate of change of the battery assembly temperature exceeds a rate threshold.

The valve 84 may be actuated by switching from a closed position to an open position. The valve 84 may have two positions (open and closed), or may be a variable valve that can be actuated to various open positions. For example, a variable valve can be controlled to regulate coolant flow into the PCM 92 based on considerations such as the type of PCM, coolant channel size and configuration, fin configuration and/or coolant pressure drop.

At block 119, after the maneuvers are complete, the cooling unit 52 may be removed from the vehicle.

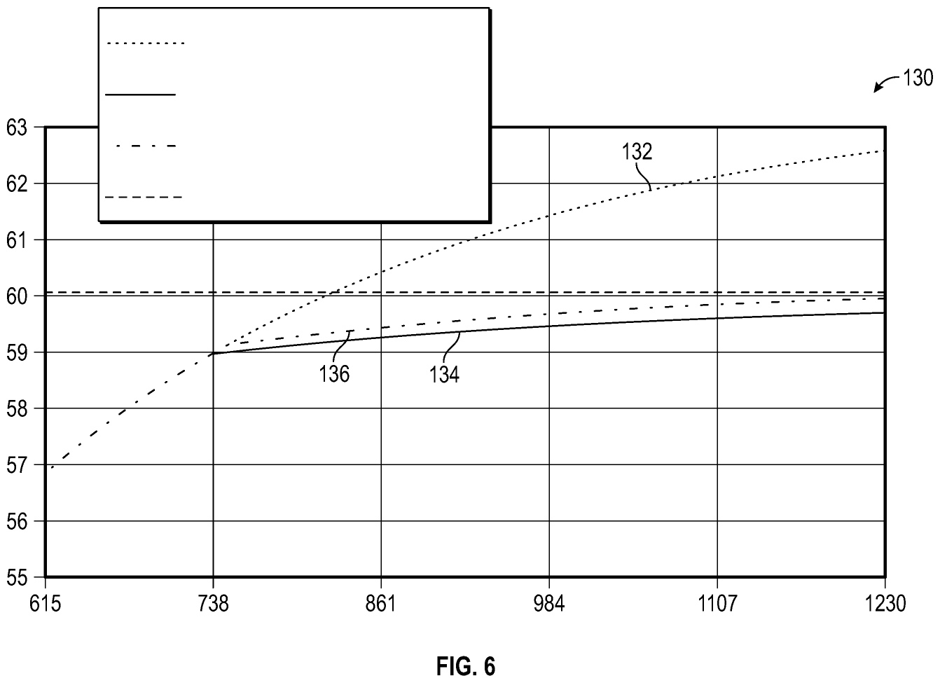

FIG. 6 illustrates an example of use of the modular thermal control system 50 in a high performance racing situation, and demonstrates the thermal management capabilities thereof. In this example, a vehicle traversed a number of laps on a racetrack using different cooling systems, and the vehicle's RESS temperature was monitored. The temperature performance of each system is represented by a graph 130 of RESS temperature as a function of time.

Curve 132 represents the RESS temperature using only the vehicle's baseline thermal management capability, without battery derating. Curve 134 represents temperature when the RESS batteries were derated to maintain the RESS below the critical temperature. Curve 136 represents temperature when the modular thermal control system 50 was used. As shown, the modular thermal control system was able to effectively maintain the RESS below the critical temperature without affecting performance.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A modular system for thermal control of a vehicle component, comprising:
a modular thermal control unit configured to be removably installed in a vehicle, the modular thermal control unit including a housing, a heat exchange component, and a connection assembly configured to removably connect the heat exchange component in thermal communication with a thermal loop of the vehicle.

2. The system of claim 1, further comprising a first fluid line and a second fluid line configured to connect the modular thermal control unit in fluid communication with a coolant line of the thermal loop.

3. The system of claim 2, wherein the connection assembly includes a detachable connector coupled to at least one of the first fluid line and the second fluid line, the detachable connector configured to removably connect at least one of the first fluid line and the second fluid line to the coolant line.

4. The system of claim 1, wherein the heat exchange component includes a phase change material (PCM).

5. The system of claim 4, wherein the modular thermal control unit includes a cavity configured to contain the PCM, and a fluid conduit configured to direct coolant from the thermal loop through the modular thermal control unit proximate to the cavity.

6. The system of claim 5, wherein the cavity includes at least one barrier, the at least one barrier configured to partition the cavity into a plurality of chambers that retain the PCM therein and permit the PCM to uniformly transition between phases.

7. The system of claim 1, wherein the modular thermal control unit is configured to be installed in an existing compartment of the vehicle.

8. The system of claim 1, wherein the vehicle component includes a battery assembly, and the thermal loop includes a thermal management assembly configured to regulate a temperature of the battery assembly.

9. A method of thermal control of a vehicle component, comprising:
installing a modular thermal control unit in a vehicle, the modular thermal control unit including a housing and a heat exchange component, wherein the installing includes removably connecting the heat exchange component in thermal communication with a thermal loop of a vehicle; and
controlling a temperature of the vehicle component by the modular thermal control unit.

10. The method of claim 9, further comprising:
during vehicle operation, monitoring a temperature of the vehicle component; and
based on the temperature exceeding or expected to exceed a selected threshold temperature, controlling the temperature by actuating the modular thermal control unit to dissipate heat from the thermal loop.

11. The method of claim 9, wherein the modular thermal control unit is connected to a first fluid line and a second fluid line, at least one of the first fluid line and the second fluid line connected to a valve, the valve configured to be actuated to put the modular thermal control unit in fluid communication with a coolant line of the thermal loop.

12. The method of claim 11, wherein the controlling includes actuating the valve to an open position in which the valve provides fluid communication with the coolant line.

13. The method of claim 12, wherein the valve is kept in the open position prior to the monitoring for a time period sufficient to prime the modular thermal control unit.

14. The method of claim 11, wherein the controlling includes actuating the valve to an open position in response to the temperature exceeding the selected threshold temperature.

15. The method of claim 9, wherein the heat exchange component includes a phase change material (PCM).

16. The method of claim 13, wherein the heat exchange component includes a phase change material (PCM), and the time period is sufficient to allow the phase change material to cool and solidify.

17. A vehicle system comprising:
a memory having computer readable instructions; and
a processing device for executing the computer readable instructions, the computer readable instructions controlling the processing device to perform a method including:
during vehicle operation, monitoring a temperature of a component of a vehicle, the vehicle including a modular thermal control unit installed therein, the modular thermal control unit including a housing and a heat exchange component, the heat exchange component removably connected to a thermal loop of the vehicle via a connection assembly; and
based on the temperature exceeding a selected threshold temperature, controlling the modular thermal control unit to dissipate heat from the thermal loop.

18. The vehicle system of claim 17, wherein the modular thermal control unit is connected to a first fluid line and a second fluid line, at least one of the first fluid line and the second fluid line connected to a valve, the valve configured to be actuated to put the modular thermal control unit in fluid communication with a coolant line of the thermal loop.

19. The vehicle system of claim 18, wherein the controlling includes actuating the valve to an open position in response to the temperature exceeding or expected to exceed the selected threshold temperature.

20. The vehicle system of claim 17, wherein the heat exchange component includes a phase change material (PCM).
